(19) United States
(12) Patent Application Publication
(10) Pub. No.: US 2010/0156381 A1
(43) Pub. Date: Jun. 24, 2010

(54) Voltage Regulating Device for Load Starting

(76) Inventors: Daming Shi, Shenzhen (CN); Xiangjun Dai, Shenzhen (CN); Qingfei Zheng, Shenzhen (CN); Aimei Zhou, Shenzhen (CN)

Correspondence Address: MORGAN, LEWIS & BOCKIUS, LLP. (PA), 2 PALO ALTO SQUARE, 3000 EL CAMINO REAL, SUITE 700, PALO ALTO, CA, 94306, US

(21) Appl. No.: 12/634,656

(22) Filed: Dec. 9, 2009

(30) Foreign Application Priority Data
Dec. 18, 2008 (CN) 200820235640.0

(51) Int. Cl. G05F 3/08

(52) U.S. Cl. 323/311

(57) ABSTRACT

The present invention provides a voltage regulating device for load starting, wherein the voltage regulating device comprises a voltage regulating circuit, and a switch circuit configured to be operably coupled between an output terminal of voltage regulating circuit and a load; wherein the switch circuit is configured to disconnect the voltage regulating circuit from the load when the voltage regulating circuit connects to a DC power.

### CROSS REFERENCE TO RELATED APPLICATION

This application claims priority to and benefit of Chinese Patent Application No. 200820235640.0, filed on Dec. 18, 2008, the entire contents of which are hereby incorporated herein by reference.

### BACKGROUND OF THE INVENTION

1. Field of the Invention

The present invention relates to an electronic circuit field, in particular, relates to a voltage regulating device for load starting.

2. Background of the Related Art

In a power system, DC power supply often needs to be boosted to meet the requirement of electronic loads. However, the electronic loads always demonstrate a capacitive character or an inductive character. The capacitive characterized load will have a transient short-circuiting when the DC power is turned on, i.e., a sharp transient starting current will be generated at the moment the DC power is turned on. Accordingly, the circuit may not work properly due to an over-current protection of the DC voltage regulating circuit, and due to an insufficient voltage output.

When the conventional voltage regulating device starts with load, as shown in FIG. 1, the DC power (1) gets connected, the capacitive characterized load (4) has a transient short-circuiting, the over-current protection of the voltage regulating circuit (2) is activated by a sharp transient starting current. Therefore, the entire circuit may be broken immediately.

### SUMMARY OF THE INVENTION

To solve the above problem, the present invention provides a voltage regulating device for load starting.

According to an embodiment of the invention, a voltage regulating device for load starting is disclosed, wherein the voltage regulating device comprises a voltage regulating circuit, and a switch circuit configured to be operably coupled between an output terminal of voltage regulating circuit and a load; wherein the switch circuit is configured to disconnect the voltage regulating circuit from the load when the voltage regulating circuit connects to a DC power.

Other variations, embodiments and features of the present disclosure will become evident from the following detailed descriptions, drawings and claims.

### BRIEF DESCRIPTION OF THE DRAWINGS

Exemplary embodiments of the present invention will be described in detail based on the following figures, wherein:

FIG. 1 shows a block diagram of a current voltage regulating device;

FIG. 2 shows a block diagram of a voltage regulating device for load starting according to one embodiment of present invention;

FIG. 3 shows a circuit diagram of a voltage regulating device for load starting according to EMBODIMENT 1;

FIG. 4 shows a circuit diagram of a voltage regulating device for load starting according to EMBODIMENT 2; and

FIG. 5 shows a sequential waveform diagram of a voltage regulating device for load starting according to one embodiment of the present invention.

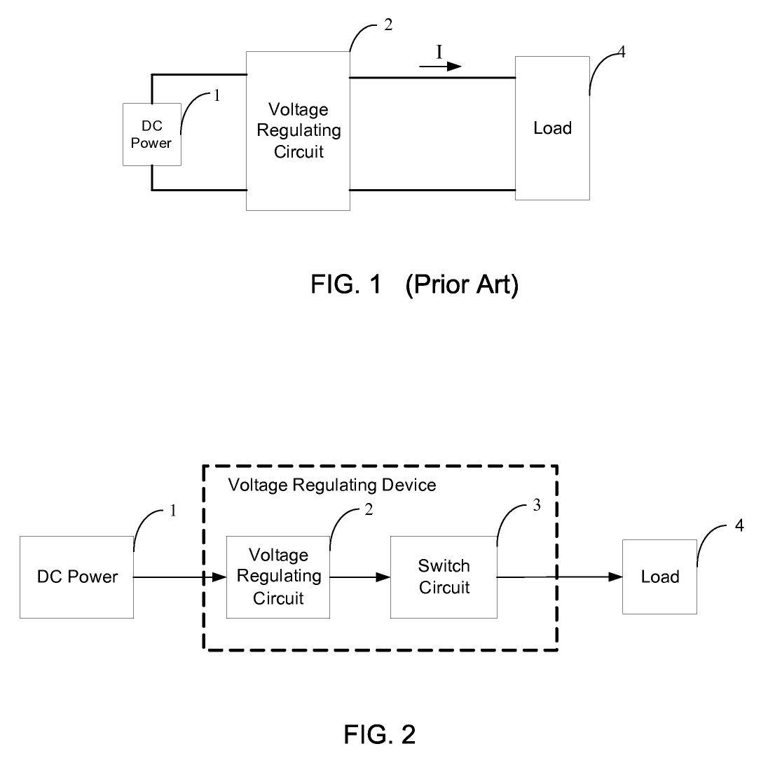

### DETAILED DESCRIPTION OF THE EMBODIMENTS

As shown in FIG. 2, a voltage regulating device for load starting is disclosed, which comprises a voltage regulating circuit (2) and a switch circuit (3). An input terminal of voltage regulating circuit (2) is configured to be operably coupled to a DC power (1); an output of voltage regulating circuit (2) is configured to be operably coupled to one end of the switch circuit (3); and the other end of the switch circuit (3) is configured to be operably coupled to a load (4). Further, the voltage regulating circuit (2) is configured to boost the output voltage of the DC power (1) to supply to the load (4); and the switch circuit (3) is configured to disconnect the voltage regulating circuit (2) from the load (4) when the voltage regulating circuit (2) connects to the DC power (1).

When the DC power (1) is not connected to the voltage regulating circuit (2), the switch circuit (3) is turned off, and the load (4) has no power supply. At the moment the DC power (1) is connected to the voltage regulating circuit (2), electric currents are only generated in the voltage regulating circuit (2). No electric currents pass through the load (4). The time delay of starting the voltage regulating circuit (2) may be configured as a variable. Once the DC power (1) is connected to the voltage regulating circuit (2), the delay function of the voltage regulating circuit (2) is configured to delay the starting time of the voltage regulating circuit (2). Accordingly, the strength of a transient starting current is eliminated. After the voltage regulating circuit (2) gets started normally, the switch circuit (3) is configured to be turned on to supply power to the load (4). Accordingly, the influence of the capacitive characterized load to the voltage regulating device is eliminated.

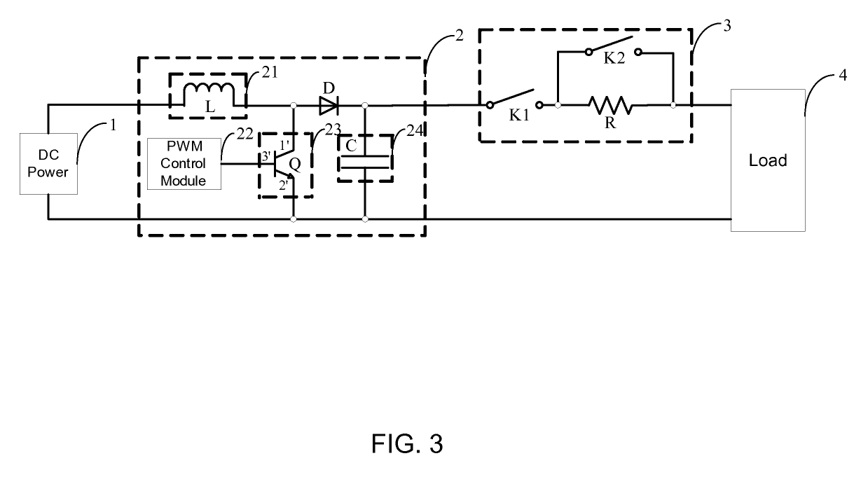

As shown in FIG. 3, the voltage regulating circuit (2) comprises: a PWM control module (22), a switch unit (23), a first energy storage unit (21), a second energy storage unit (24), and a diode (D); wherein, a first terminal (1′) of the switch unit (23) is configured to be operably coupled to the output terminal of the DC power (1) via the first energy storage unit (21), a second terminal (2′) of the switch unit (23) is configured to be operably coupled to ground, a control terminal (3′) of the switch unit (23) is configured to be operably coupled to the PWM control module (22), an anode of the diode (D) is configured to be operably coupled to the first terminal (01) of the switch unit (23), a cathode of the diode (D) is configured to be operably coupled to the switch circuit (3), one end of the second energy storage unit (24) is configured to be operably coupled to the cathode of the diode (D), and the other end of the second energy storage unit (24) is configured to be operably coupled to ground. In some embodiments, the switch unit (23) comprises a transistor (Q), the first energy storage unit (21) comprises an inductor (L), and the second energy storage unit (24) comprises a capacitor (C).

According to one embodiment of the present invention, as shown in FIG. 2, the PWM control module (22) is configured to control the transistor (Q) to turn on and off. When the transistor (Q) is turned on, the voltage signal transmitted by the DC power (1) is configured to connect to the circuit via inductor (L), and the electric current passing through the inductor (L) increases linearly from zero value. According to the Faraday Electromagnetic Induction Law:

$$u = L \cdot \frac{d i}{d t} ,$$

the voltage of the anode of diode (D) becomes negative, and the diode (D) becomes reverse-biased, which is inconsistent with the conducting condition of a diode. Meanwhile, the capacitor (C) is configured to supply power to the load (4). When the transistor (Q) is turned off, the electric current passing through the inductor (L) gradually decreases. According to the Faraday Electromagnetic Induction Law:

$$u = L \cdot \frac{d i}{d t} ,$$

the voltage of the anode of diode (D) becomes positive, the diode (D) becomes forward-biased. The DC power (1) is configured to charge the capacitor (C), and further supply power to the load (4) via the inductor (L).

The switch circuit (3) comprises a first switch (K1) configured to be connected between the output terminal of voltage regulating circuit (2) and the load (4). In some embodiments, the first switch (K1) comprises a mechanical switch.

In one embodiment, the switch circuit (3) further comprises a second switch (K2) and a current-limiting resistor (R), wherein the current-limiting resistor (R) is configured to couple the first switch (K1) to the load (4), the second switch (K2) is configured to couple the first switch (K1) to the load (4) in parallel to the current-limiting resistor (R). In some embodiments, the second switch (K2) comprises a mechanical switch.

In one embodiment, each of the first and the second switch (K1, K2) is manually controlled.

In some embodiments, each of the first and the second switch comprises an electric switch unit.

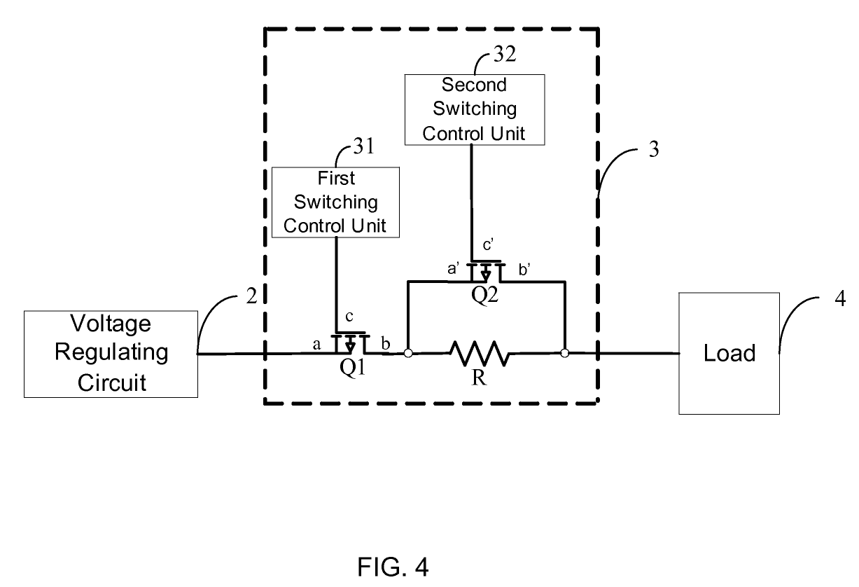

In one embodiment, as shown in FIG. 4, the first switch comprises a first electric switch (Q1) and a first switching control unit (31), a first terminal (a) of the first electric switch (Q1) is configured to be operably coupled to the output terminal of voltage regulating circuit (2), a second terminal (b) of the first electrical switch (Q1) is configured to be operably coupled to the load (4), and a control terminal (c) of the first electrical switch (Q1) is configured to be operably coupled to the first switching control unit (31). In some embodiments, the first switching control unit (31) comprises a logic control circuit comprised of an MCU or a flip-flop. In some embodiments, the first switching control unit (31) is configured to be disposed inside the voltage regulating device, for example, the first switching control unit (31) is configured to be integrated with the switch circuit (3).

In another embodiment, as shown in FIG. 4, the second switch comprises a second electrical switch (Q2) and a second switching control unit (32). The first and second terminals (a′, b′) of the second electrical switch (Q2) are configured to couple the first electrical switch to the load in parallel to the current-limiting resistor (R) and the control terminal (c′) of the second electrical switch (Q2) is configured to be operably coupled to the second switching control unit (32). In some embodiments, the second switching control unit (32) comprises a logic control circuit comprised of an MCU or a flip-flop. In some embodiments, the second switching control unit (32) is configured to be disposed inside the voltage regulating device, for example, the second switching control unit (32) is configured to be integrated with the switch circuit (3).

In some embodiments, each of the first and the second electric switch (Q1, Q2) comprises a bipolar transistor. In some other embodiments, each of the first and the second electric switch (Q1, Q2) comprises a MOS transistor.

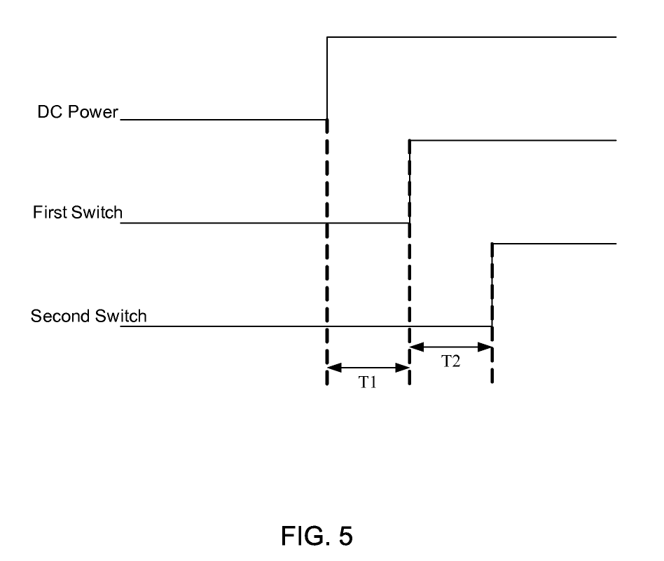

In some embodiments, as shown in FIG. 5, a sequential waveform diagram comprising: an output voltage level when the first switching control unit (31) controls the first electric switch (Q1), an output voltage level when the second switching control unit (32) controls the second electric switch (Q2), and an output voltage level of the DC power (1). Before the voltage regulating circuit (2) is turned on, the output signal of the DC power (1) stays in a low level, and the first and the second electric switches (Q1, Q2) are turned off. When the DC power (1) is connected to the voltage regulating circuit (2), the output signal of the DC power (1) reaches a high level, and the voltage regulating circuit (2) is turned on. After a delayed time T1, the output signal of the first switching control unit (31) reaches a high level to control the first electric switch (Q1) to be turned on. After a delayed time T2, the load (4) works properly, and the output signal of the second switching control unit (32) reaches a high level to control the second electric switch (Q2) to be turned on. Thus, the load (4) is completely connected to the voltage regulating circuit (2). During the entire process, the load (4) is configured to be connected to the voltage regulating circuit (2) in a segment basis. Therefore, the sharp transient starting current is eliminated, and the output voltage is generated in a normal level.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A voltage regulating device for coupling a DC power to a load, comprising:
a voltage regulating circuit; and
a switch circuit coupling an output terminal of the voltage regulating circuit and the load;
wherein the switch circuit is configured to disconnect the voltage regulating circuit from the load when the voltage regulating circuit is electrically connected to the DC power.

2. The voltage regulating device of claim 1, wherein the switch circuit comprises a first switch coupling the output terminal of the voltage regulating circuit to the load.

3. The voltage regulating device of claim 2, wherein the first switch comprises a mechanical switch.

4. The voltage regulating device of claim 2, wherein the first switch comprises a first electric switch and a first switching control unit, wherein
a first terminal of the first electric switch is configured to be operably coupled to the output terminal of the voltage regulating circuit;
a second terminal of the first electric switch is configured to be operably coupled to the load; and
a control terminal of the first electric switch is configured to be operably coupled to the first switching control unit.

5. The voltage regulating device of claim 4, wherein the first switching control unit is configured to be disposed inside the voltage regulating device.

6. The voltage regulating device of claim 2, wherein the switch circuit further comprises a second switch and a current-limiting resistor, wherein
the current-limiting resistor is configured to couple the first switch to the load, and
the second switch is configured to couple the first switch to the load in parallel to the current-limiting resistor.

7. The voltage regulating device of claim 6, wherein the second switch comprises a mechanical switch.

8. The voltage regulating device of claim 6, wherein the second switch comprises a second electric switch and a second switching control unit, wherein
the second electric switch are configured to couple the first switch to the load in parallel to the current-limiting resistor; and
a control terminal of the second electric switch is configured to be operably coupled to the second switching control unit.

9. The voltage regulating device of claim 8, wherein the second switching control unit is configured to be disposed inside the voltage regulating device.

10. The voltage regulating device of claim 1, wherein the voltage regulating circuit comprises: a PWM control module, a switch unit, a first energy storage unit, a second energy storage unit, and a diode, wherein
a first terminal of the switch unit is configured to be operably coupled to an output terminal of the DC power via the first energy storage unit;
a second terminal of the switch unit is configured to be operably coupled to ground;
a control terminal of the switch unit is configured to be operably coupled to the PWM control module;
an anode of the diode is configured to be operably coupled to the first terminal of the switch unit;
a cathode of the diode is configured to be operably coupled to the switch circuit;
a first terminal of the second energy storage unit is configured to be operably coupled to the cathode of the diode; and
a second terminal of the second energy storage unit is configured to be operably coupled to ground.

11. The voltage regulating device of claim 10, wherein the switch unit comprises a transistor.

12. The voltage regulating device of claim 11, wherein the transistor is a bipolar transistor.

13. The voltage regulating device of claim 11, wherein the transistor is a MOS transistor.

14. The voltage regulating device of claim 10, wherein the first energy storage unit comprises an inductor.

15. The voltage regulating device of claim 10, wherein the second energy storage unit comprises a capacitor.

16. The voltage regulating device of claim 10, wherein the PWM control module is configured to control the on/off of the switch unit.

17. A method for coupling a DC power to a load using a voltage regulating device, wherein the voltage regulating device includes a voltage regulating circuit that is electrically coupled to the DC power and a switch circuit that couples the voltage regulating circuit to the load, comprising:
switching off the switch circuit;
applying the DC power to the voltage regulating circuit for a predefined period of time; and
switching on the switch circuit such that the DC power is applied to the load.

18. The method of claim 17, wherein the switch circuit includes a first switch and a second switch that is serially connected to the first switch.

19. The method of claim 18, further comprising:
switching off both the first and second switches of the switch circuit;
applying the DC power to the voltage regulating circuit for a first predefined period of time; and
switching on the first switch of the switch circuit while the second switch of the switch circuit remains switched off.

20. The method of claim 19, further comprising:
applying the DC power to the voltage regulating circuit for a second predefined period of time; and
switching on the second switch of the switch circuit while the second switch of the switch circuit remains switched on.
